(19) United States
(12) Patent Application Publication
(10) Pub. No.: US 2010/0321300 A1
(43) Pub. Date: Dec. 23, 2010

(54) KEYBOARD LAYOUT

(75) Inventor: Farookh Shaikh Usman, Singapore (SG)

Correspondence Address: OCCHIUTI ROHLICEK & TSAO, LLP, 10 FAWCETT STREET, CAMBRIDGE, MA, 02138, US

(73) Assignee: ICOMET SPA, Latina (IT)

(21) Appl. No.: 12/526,175

(22) PCT Filed: Jan. 31, 2008
(86) PCT No.: PCT/SG2008/000033

§ 371 Date: Aug. 6, 2009

(30) Foreign Application Priority Data
Feb. 7, 2007 (AU) 2007900583

(51) Int. Cl. G06F 3/02

(52) U.S. Cl. 345/168

(57) ABSTRACT

A unique keyboard configuration and a keyboard form factor are provided. The keyboard configuration is formed from several keys arranged in a substantially handprint configuration on a housing. Each key is assigned more than one letter input. To actuate any one of the letter inputs assigned to a key, only a single actuation of the key is needed. Each key may be momentarily movable to more than one position, from the rest position, each position corresponding to generating a pre-assigned letter input.

The invention relates to an input device for entering data into a computing device. More particularly, the invention relates to a unique keyboard layout and a form factor for providing a single-hand operation.

### BACKGROUND

With increasing dependence on computers and computing devices, data entry devices such as keyboards have taken on an important role in modern lifestyle. Advancement in electronics has brought tremendous progress to keyboard technology since the days of a typewriter. Yet, the layout of keys on a keyboard has undergone little change.

The standard QWERTY keyboard layout, as named for the first six keys of the top row has been used since manual typewriters. This layout is believed to have been designed to overcome certain limitations with manual typewriters. Manual typewriters are operated by depressing keys on a board to activate metal levers bearing the corresponding typefaces to be imprinted on a paper. If a typist hit certain combinations of keys in rapid succession, the corresponding levers would collide and engage with each other. Having to stop typing to separate the engaged levers reduces typing efficiency and also causes frustration to the user. The QWERTY layout is reported to place common two-letter combinations on opposite sides of a keyboard to reduce such occurrences. Today, although keyboards are mostly operated by microprocessors, keyboards are still being widely manufactured with the QWERTY layout as this layout has been long established as a standard and people have become accustomed to this layout.

Attempts have been made to adopt the DVORAK layout, which was named after its creator Dr. August Dvorak. This layout is designed to place most commonly used letters in a convenient arrangement. However, the DVORAK layout has not gained as much popularity.

As computing devices continually miniaturize, the standard keyboard layouts and sizes have become a limitation to the form factor of the device. To overcome this limitation, there have been attempts to shrink the QWERTY layout as well as other layouts into a small form factor. One example is the FrogPad™ keyboard provided by FrogPad Inc. for one-handed data entry into a computing device. Although this type of configuration and form factor allow its users to enjoy the conveniences of a small form factor and single-hand operation, users' data entry speed is often impeded or even slowed simply because users are usually required to strike more than one key in order to generate the secondary letters.

In view of the foregoing, it is desirable to provide a keyboard layout that can increase data entry speed and provides a single-hand operation, while allowing a user access to the conveniences of a small form factor.

### SUMMARY OF THE INVENTION

According to one aspect, an input device is provided for entering data into a computing device, the input device comprising:

a supporting structure, such as a housing;

a plurality of primary keys mounted on the supporting structure, and

at least one of the primary keys comprising a multi-function input device operable by a single finger of a user and having a plurality of actuation modes each of which is associated with different input data for the computing device.

The multi-function input device preferably comprises a pad mounted over a plurality of momentary action switches whereby rocking the pad in each one of a plurality of directions operates a corresponding one of the switches. The multi-function input device may include a further switch which is operated by depressing the pad without rocking it. Preferably the multi-function input device comprises five switches whereby rocking the pad in each one of four directions on substantially perpendicular axes operates a corresponding one of four switches and depressing the centre of the pad operates the fifth switch.

A first secondary key may also be provided to perform a shift function and operation of each of the primary keys may generate one of a plurality of un-shifted inputs or one of a further plurality of shifted inputs.

Preferably five primary keys are positioned relative to one another to along an approximately arcuate line such that the tips of the four fingers and thumb of a users hand will naturally adopt the positions of the primary keys.

In one possible embodiment, each primary key is assigned a maximum of one actuation mode associated with an input data value comprising a vowel selected from the group of “a”, “e”, “i”, “o” and “u”. In this embodiment:

an “s”, an “a”, an “I” and a “c” are assigned to a first of the primary keys,

a “d”, an “i”, an “m” and a “p” are assigned to a second of the primary keys,

an “f”, a “v” and an “x” are assigned to a third of the primary keys,

a “z”, a “q” and a “j” are assigned to a fourth of the primary keys,

a “w”, a “u”, a “k” and a “y” are assigned to a fifth of the primary keys.

a “t”, an “e”, an “r” and an “n” are assigned to a first secondary key, and an “h”, an “o”, a “b”, and a “g” are assigned to a second secondary key.

A third secondary key may be located proximate to one of the primary keys, wherein the third secondary key and the proximate primary key are alternatively accessible by a single finger or thumb. A fourth secondary key may be located proximate to another of the primary keys, wherein the fourth secondary key and the proximate primary key are alternatively accessible by a single finger and the second secondary key also provides a shift function.

A positioning device, such as a cursor key, may be arranged proximate to one of the primary keys, wherein the positioning device and one of the primary keys are alternatively accessible by a single finger in use.

Adjustment means may be associated with at least one of the primary or secondary keys wherein the position of the associated primary or secondary key is movable relative to the other keys by operating the adjustment means. The adjustment means may for example comprise a knob or lever.

The supporting structure may include an opening formed in the supporting structure to receive a hand and the primary and the secondary keys are located in the opening and accessible by placing a hand in the opening. The supporting structure is preferably contoured to conform to a hand of a user. The supporting structure may be arranged to be worn on a person, and may, for example, be in the form of a glove. If the supporting structure is in the form of a glove, the undersurface of the glove may include a screen.

The input device may also be incorporated into a computing device which further comprises:

a display; and

a processor capable of receiving data from the input device and outputting the data on the display, wherein the input device is a keyboard comprising:
a housing; and
a plurality of keys mounted in the housing, at least some of the keys being positioned relative to one another along an approximately arcuate line such that the tips of the four fingers and thumb of a user's hand will naturally adopt the positions of the primary keys,

According to another aspect, an input device for entering data into a computing device using a single-hand operation, the input device comprising:

a supporting structure; and

a plurality of keys mounted in the supporting structure, at least a portion of the keys being positioned relative to one another along an approximately arcuate line such that the tips of the four fingers and thumb of a user's hand will naturally adopt the positions of the primary keys,

wherein each of the keys is assigned a plurality of inputs, each of the inputs is generated by a single actuation of a corresponding key, and
wherein the keys are capable of generating inputs corresponding to a full range of English letters.

Embodiments of the input device provide a keyboard layout for single-hand operation that has a small form factor and increases data entry speed. The keyboard preferably includes a housing and several keys attached to the housing in a substantially handprint configuration. The substantially handprint configuration is designed for ergonomic placement of a user's fingers on the keyboard as well as for reducing finger travel distances while typing. Each of the several keys is assigned a plurality of inputs, each of which is generated by a single actuation. Each key is movable between two or more distinguishable positions to generate a corresponding input assigned to each position.

The preferred keyboard layout will be in a non-QWERTY configuration. For example, vowel letters may be assigned to separate keys. Non-vowel letters may be assigned to keys so that the non-vowel letters, in conjunction with vowel letters of each key, than a mnemonic or even a word. This will assist users who are not accustomed to this layout in memorizing the layout more easily and also assist seasoned users in increasing their typing speeds.

Further, more commonly used letters are preferably assigned to keys that are designed for actuation by the thumb, index finger and middle finger. These three fingers generally have greater strength and agility and therefore would be more frequently used in the present keyboard layout. Other less-commonly-used letters are preferably assigned to keys that are designed for actuation by the ring finger and little finger, which are less agile and have lesser strength. Further, certain keys could also be designated for use by PC garners.

The present keyboard is particularly advantageous in providing an ergonomic design in a small form factor while not compromising a user's data entry speed. Instead, a user's data entry speed is greatly enhanced by using mnemonics to assign letters to the various keys. The present keyboard is also advantageous in providing single-hand operation, thereby allowing a user to multi-task with the other hand. The single-hand operation of the present keyboard also provides ease of use to a user who is disabled due to illness, age or mishap etc.

### BRIEF DESCRIPTION OF DRAWINGS

Embodiments of the present single-handed operation keyboard will now be described in greater detail, by way of example, with reference to the accompanying drawings in which:

FIG. 1 illustrates a normal QWERTY keyboard layout.

FIG. 2 illustrates a block diagram of a computing system embodying the present keyboard.

FIG. 3 illustrates a first embodiment of a keyboard layout for right-hand operation with a keypad inbuilt or detachable on the keyboard layout.

FIG. 4 illustrates a keyboard similar to that of FIG. 3 but for left-hand operation.

FIG. 5 illustrates a further embodiment of a keyboard layout for right-hand operation.

FIG. 6 illustrates a keyboard similar to that of FIG. 5 but for left-hand operation.

FIGS. 7 (a) and (b) illustrate an example of a mini laptop in a notebook configuration with a camera installed with a keyboard layout according to one of the present embodiments. The mini laptop is shown in an open position in FIG. 7(a) and in a closed position in FIG. 7(b).

FIGS. 8 (a), (b) and (c) illustrate an example of a slab housing that includes a keyboard layout according to one of the present embodiments and which receives a user's hand. FIG. 8(a) shows the front view of the housing, FIG. 8(b) shows the top view and FIG. 8(c) shows the back view.

FIG. 9 illustrates an example of a mini laptop with a camera installed and with a keyboard layout as described herein and a separate keypad telephone extension device connected to the keyboard layout.

FIGS. 10 (a) and (b) illustrate an example of a keyboard layout that can be worn on the palm of one's hand like a glove. FIG. 10(a) shows the top view of the glove and FIG. 10(b) shows an undersurface view of the glove.

FIGS. 11(a) and (b) illustrate an example of a keyboard layout that has an additional facility which allows key positions to be marginally moved up, down and sideways to adjust to an individual user's hand. FIG. 11(b) is an enlarged view of the additional facility of FIG. 11(a).

### DETAILED DESCRIPTION OF A KEYBOARD LAYOUT

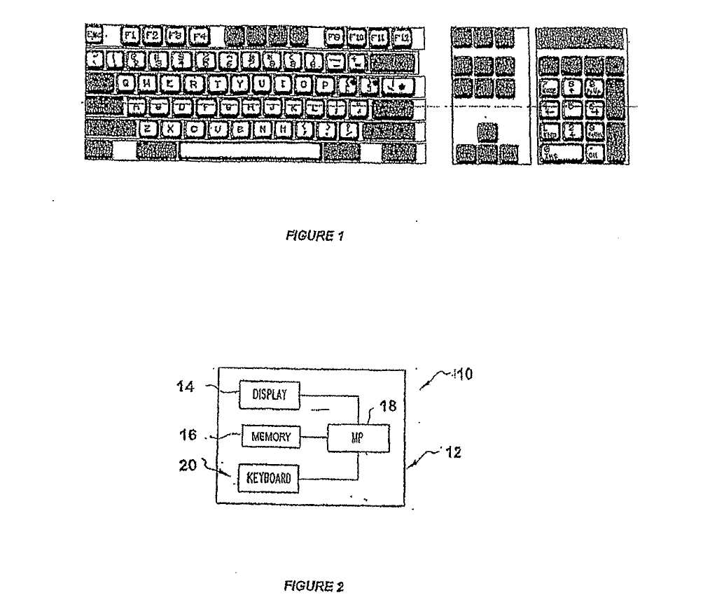

FIG. 1 illustrates a typical QWERTY keyboard for providing standard English letter keys, punctuation keys, numeric keys, function keys and control keys which are arranged in rows and columns. Each English letter and number from 0 to 9 is assigned a key each. In addition, function keys and control keys, including Tab, Alt, Delete, Backspace, Return, Shift and Control are also assigned to a key each.

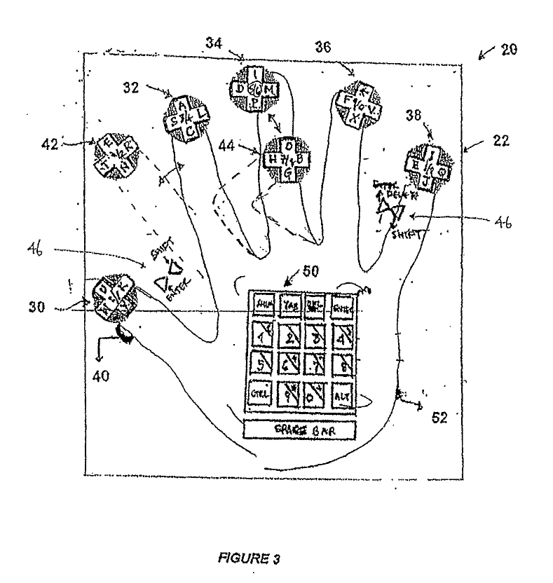

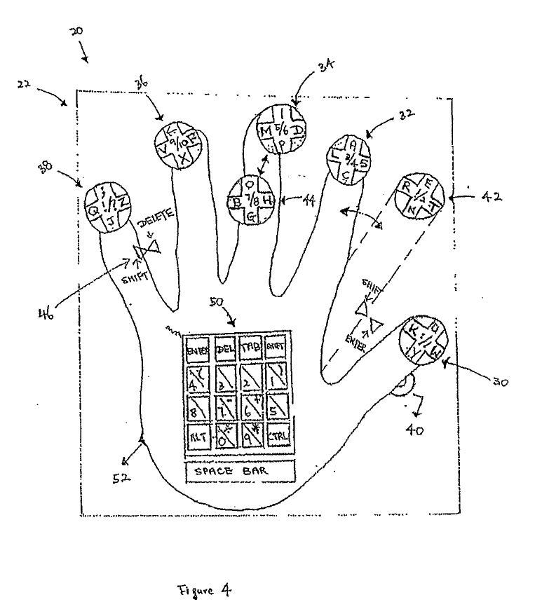

FIG. 2 illustrates a computing system in which a single hand operation keyboard may be utilized. Such a computing system can include any computing device requiring alphanumeric inputs, such as: a PC, a PDA, a laptop computer, a tablet PC, an inventory recorder, a wireless device, a mobile phone, etc. Referring to FIG. 3, the device 10 of FIG. 2 includes, inter alia, a device housing 12, an input device or keyboard 20, a display 14, a memory 16 and a processor 18 or microprocessor capable of electrical communication with both the keyboard and the display. The processor 18 is also capable of receiving data from the keyboard 20 and displaying the data on the display 14 by means of program instructions residing in the computing device 10. The processor 18 is further capable of storing inputs from the keyboard 20 in the memory 16 and retrieving from the memory 16 for output to the display 14.

FIG. 3 illustrates a keyboard layout for right-hand operation. The handprint outline in FIG. 3 illustrates a possible posture with which a user's hand is poised for typing on a keyboard for single handed operation as described herein. The keyboard 20 comprises a housing 22 and several primary keys attached to the housing 22 in a substantially handprint configuration. The substantially handprint configuration should be understood to include any spread-out configuration that allows a user's hand to be placed in a home position. The home position follows an intuitive placement of a user's fingers in a posture poised for typing or in an outstretched relaxed position. An example of a home position as illustrated in FIG. 3 refers to a thumb placed on key 30, an index finger placed on key 32, a middle finger placed on key 34, a ring finger placed on key 36 and a little finger placed on key 38.

The keyboard housing 22 also includes at least one secondary key arranged in proximity to one of the primary keys for alternative access by a user's finger. As an illustration with reference to FIG. 3, a secondary key 42 is arranged proximate to a primary key 32, which is positioned for access by an index finger in a home or first position. The secondary key 42 is positioned on the housing for alternative access by the index-finger in a second position which is away from the home position. FIG. 3 shows the placement of the index finger in the second position (in dotted lines) after movement of the index finger from primary key 32 to secondary key 42.

Other secondary keys may be provided on the housing 22, such as a secondary key 44, which is positioned for access by a middle finger in a home position. The secondary key 44 is positioned proximate to primary key 34 for alternative access by a middle finger in the second position. FIG. 3 shows the bent placement of the middle finger in the second position (in dotted lines) and also the movement of the index finger between primary key 34 and secondary key 44. Further secondary keys 46 may be provided on the housing 22 to operate as control and function keys.

A cursor positioning device such as a wheel-operated mouse or a touch pad may be attached to the housing in proximity with another primary key. For example as shown in FIG. 3, a pointer mouse 40 is arranged in close proximity to key 30 for access by a thumb.

The further secondary keys 46 may be provided as function and/or control keys and may be arranged on the housing in proximity to another primary key. For example as shown in FIG. 3, a control key 46 is arranged in proximity for alternative access by a thumb with primary key 30 and by a little finger with primary key 38. Such a control key 46 may provide functions such as Delete, Shift, Control, Return or Enter and activation of software applications. The control key 46 may be programmable by a user according to his requirements. In addition, a space bar may be arranged in conjunction with the primary keys such that the space bar is accessible by the bottom part of a user's palm. Certain keys can also be designated for use by PC garners.

As an optional feature, embodiments of the one-handed operation keyboard may provide a separate keypad 50 containing numeric keys, function keys and/or control keys. Such a keypad 50 to facilitate communications may have keys arranged in rows and columns such as that shown in FIG. 3. The keypad 50 may be inbuilt or detachable with a retractable cord or connected via wireless (Bluetooth, infrared, etc). The keypad 50 may also function either as a handphone or as an input device for a handphone when the keyboard is attached to a handphone device. A selector switch 52 may be provided on the keyboard to enable a user to activate the handphone operation mode.

The one-handed keyboard layout described herein provides an ergonomic layout for a single-hand operation. It is also designed to reduce space required for housing the keys while being capable of generating at least a full range of English letters. It is also designed to increase data entry speed as the spread-out configuration reduces finger travel distances as compared to a standard QWERTY keyboard.

Data entry speed may be further enhanced by the non-QWERTY layout of letter inputs. The arrangement is directed to provide an easily-memorized and user-friendly layout. A first-time user of the present keyboard would therefore require little time to memorize the letter layout. An exemplary layout of the one-handed keyboard is illustrated in FIG. 3 and in Table 1 below.

TABLE 1
Example Layout

| | Primary Keys | Secondary Keys |
|---|---|---|
| Thumb | “w”, “u”, “k”, “y” | — |
| Index Finger | “s”, “a”, “l”, “c”, | “t”, “e”, “r”, “n” |
| Middle Finger | “d”, “i”, “m”, “p” | “h”, “o”, “b”, “g” |
| Ring Finger | “f”, “<-”, “v”, “x” | — |
| | (<- backspace) | |
| Little Finger | “z”, “;”, “q”, “j” | |

The layout exemplified in Table 1 is designed in view of the following considerations. The thumb, index finger and middle finger generally have the greatest strength and agility. These three fingers are therefore assigned letters that are most commonly used. The ring finger and little finger (in that order) have lesser strength and agility, and are therefore assigned letters that are used less frequently. Vowel letters, such as “a”, “e”, “i”, “o”, and “u” are arranged on separate keys. Vowels, being commonly used, are each arranged on a different key to assist the memory process through forming mnemonics and words. Assignment of non-vowel letters to the primary and secondary keys are based on the consideration that more commonly used characters are to be accessed by the thumb, index finger or middle finger. Further, to assist a user to quickly memorize and adapt to the layout, non-vowel letters are arranged in conjunction with the vowel character assigned to each key such that they may form a mnemonic or even a word.

In prior art keyboards where more than one letter is assigned to a key, a user may have to actuate more than one key sequentially or in combination to generate certain letters. In the present one-handed keyboard however, although more than one letter is assigned to each key, each letter input is actuated by a single or sole keystroke or actuation.

To achieve this single-actuation feature, a rocker button or pad may be used for at least some of the primary and secondary keys. The rocker button or pad is similar to the well known “D-pad” used in popular game controllers telephones, digital cameras etc as a direction button. A person skilled in the art would appreciate that a rocker button provides more than two distinguishable actuation positions, each of which is to generate a pre-assigned input when activated. The rocker buttons illustrated in FIG. 3 each provide a user with five operative actions comprising depressing or actuating the rocker button on its i) front, ii) back, iii) left, iv) right and v) centre areas. Therefore, a user merely depresses a portion of the rocker button to generate a corresponding pre-assigned input. This way, each of the inputs assigned to a rocker button is generated by a single actuation or keystroke without having to actuate a combination of keys. In the example of FIG. 3, a full range of English letters can be generated by a single actuation of each position of each key. Capital letters may be generated by depressing one or other of the Shift buttons 46 in combination with a corresponding letter key position. In the example of FIG. 3, each key can generate ten pre-assigned inputs, namely four lower cases and four upper cases of the letters and two numerals/non-numerals.

The keyboard housing 22 should also provide an interface (not shown in FIG. 3) with which the keyboard transmits input signals to a computing device. Such an interface includes a DIN (Deutsche Industrie Norm) connector, an IBM PS/2 mini-DIN connector and a USB connector. A wireless interface such as Bluetooth and infra-red ports may be provided instead or as an additional feature. The housing 22 may also provide a support pad to reduce strain on the hand, wrist or fingers while entering data using the keyboard.

FIG. 4 illustrates a keyboard layout according to one embodiment of the present one-handed keyboard layout for left-hand operation. The keyboard layout for left-hand operation is a mirror image of that depicted in FIG. 3.

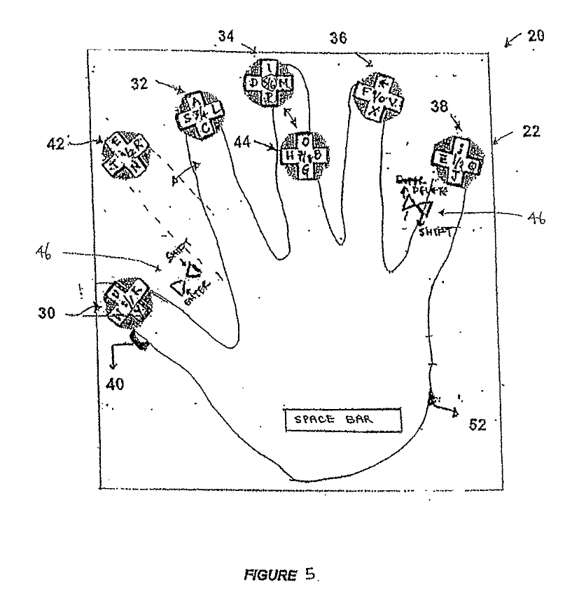

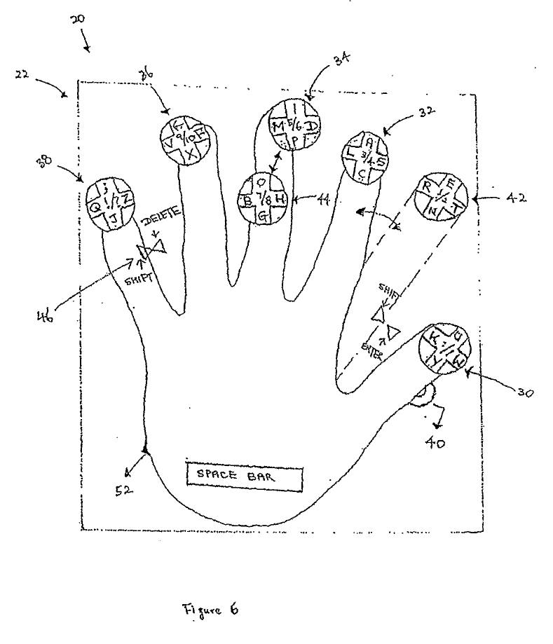

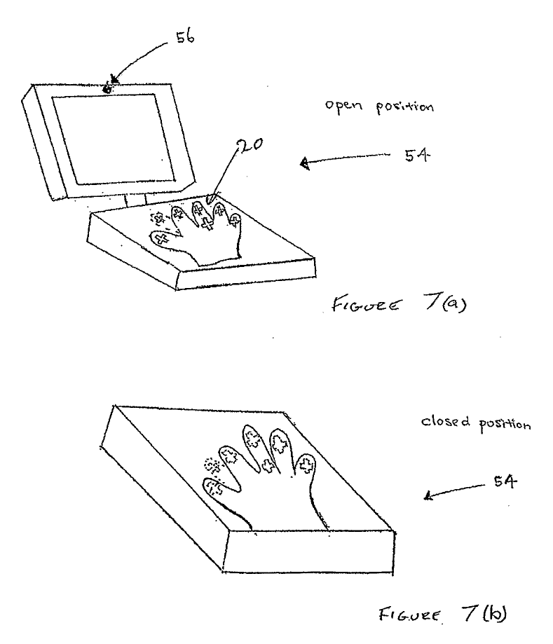

FIGS. 5 and 6 illustrate a one-handed keyboard layout without the optional keypad 50.

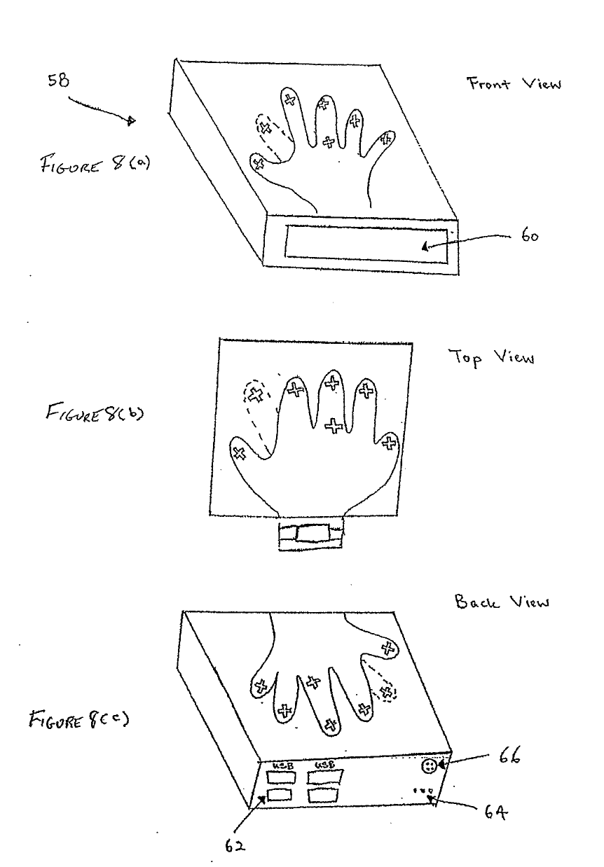

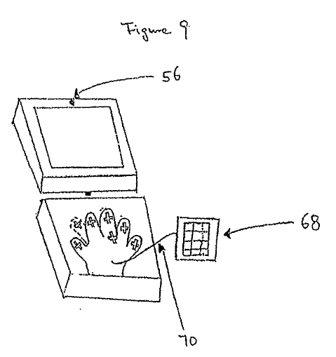

The one-handed keyboard 20 and housing 22 may be implemented in various ways. An example is a slab or flat form factor, which may be rigid or foldable. An example of how the present keyboard layout can be implemented onto a mini laptop 54 in a notebook configuration with a camera 56 is shown in open and closed positions respectively in FIG. 7(a) and FIG. 7(b). A keyboard layout 20 is located on the laptop 54 which allows the user to use one hand to type and at the same time use the camera 56. As seen in FIG. 7(b), the screen portion may be swiveled and folded under the keyboard to allow keying with the laptop closed. A slab housing 58 such as that illustrated in FIGS. 8(a) -8(c) may have an opening 60 formed in the housing 58 to receive a user's hand. The housing 58 is built with the present keyboard layout 20 as shown in FIG. 8(a). The housing 58 may include USB ports 62 to attach to computer system/laptop. The housing 58 may also include sockets 64 to receive an earphone jack and a mouse port 66 as shown in FIG. 8(c). The housing may also attach to a game console for playing computer/TV games. Certain keys on the keyboard can also be designated for use by PC garners.

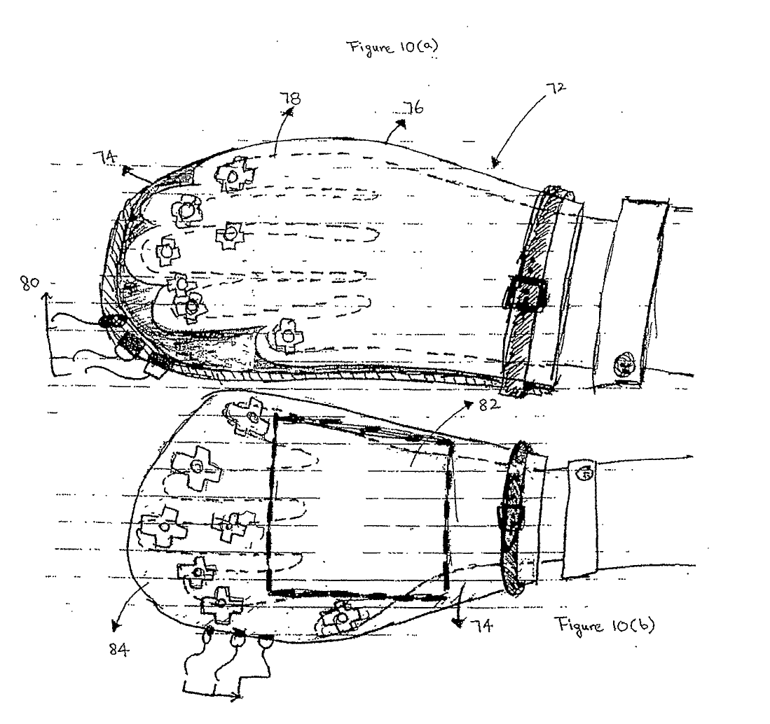

A further example of how the present keyboard layout can be implemented onto a mini laptop camera 56 is illustrated in FIG. 9. In this example a separate keypad telephone device 68 can be connected to the keyboard layout via an extension 70 and is otherwise the same as the FIG. 7 embodiment. This can facilitate sending short message service and sending emails on the go.

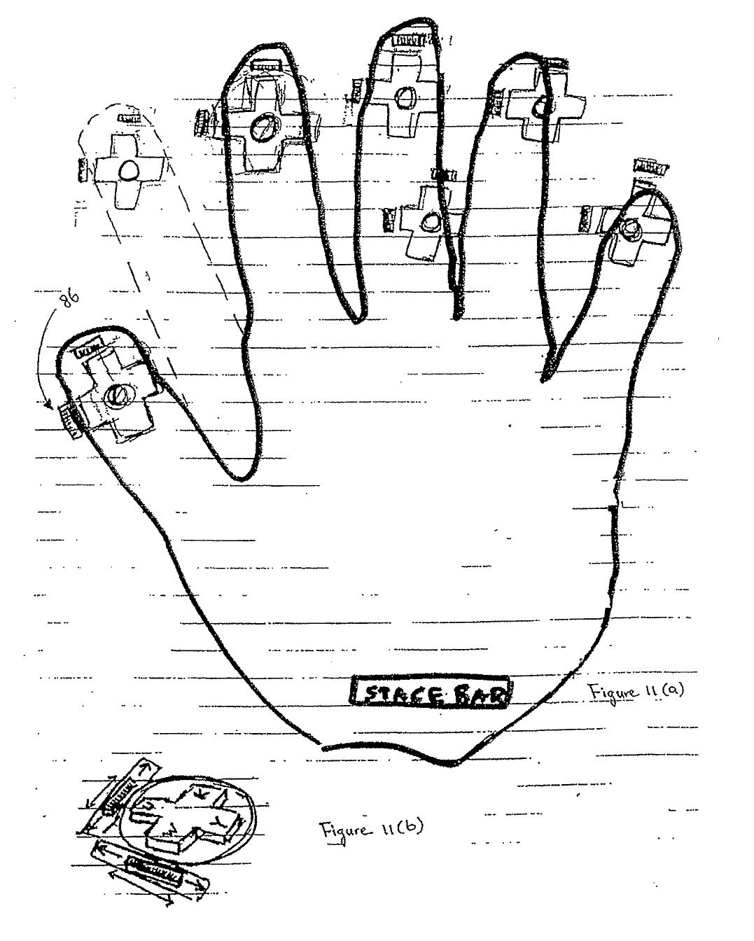

Another example is a wearable format that could be fitted or contoured to conform to a user's hand, such as a glove. This format is advantageous especially if the user is performing data entry or sending short message service while travelling or commuting. This wearable format does not take up a large space and is not heavy. While travelling or commuting, for instance, a laptop will need a larger space and a flat surface. Both hands are also required for maximum usage. This is particularly difficult for the handicapped. An example of this format which allows the present keyboard layout to be worn on the palm of a user's hand like a glove 72 is illustrated in FIGS. 10(a) and (b). The top surface (back) of the glove 72 seen in FIG. 10(a) can be made of soft to semi-soft material and the undersurface (palm) of the glove seen in FIG. 10(b) should be made of hard base 74 such as plastic, since a hard surface will offer a base for resting the palm. The glove 72 should also have an upraised enclosure 76 on the underside of the glove and which is made of soft to semi-soft material. Key locations 78 and finger positions 78 are located inside the glove, on the undersurface as shown in FIG. 10(a). The glove 72 can also have cable ports 80, such as a DIN (Deutsche Industrie Norm) connector, an IBM PS/2 mini-DIN connector and a USB connector. An optional screen 82 approximately the size of the middle of the palm can be incorporated on the undersurface 84 of the glove 72 as shown in FIG. 10(b).

Embodiments of the present one-handed keyboard layout are particularly advantageous to various segments of users because of the single-hand operation. They are particularly ideal for handicapped users who may be able to operate only one hand, and also for other users who may need to multi-task while entering data. It is also ideal for users who have small-sized hands, such as children and even adults. Although the size of the keyboard layout is approximately that of the standard glove sizes, keyboards of different sizes may be made available or customized to cater to different user segments. An additional facility 86 such as tiny knobs/levers can be positioned adjoining to each primary key and to each secondary key to allow minor adjustments to the key positions as illustrated in FIG. 11(a). By adjusting the additional facility 86, the positions of the primary and secondary keys can marginally move up, down and sideways to adjust to a user's hand. FIG. 11(b) shows an enlarged view of the additional facility 86. Certain keys can also be designated for use by PC garners.

In addition, the present one-handed keyboard allows a user to enter standard letter inputs with a single actuation even though the keyboard has a reduced number of keys and has more than one letter input assigned to a single key. Other prior art keyboards having more than one letter assigned to a single key may require actuating more than one key to enter certain characters, thereby slowing data entry speed. The present one-handed keyboard improves data entry speed by, first, allowing single actuation for standard letter inputs, and, second, disposing the keys in an ergonomic arrangement to reduce travel distances of a user's fingers when operating the keyboard. In short, the present invention provides users with the conveniences of a small form factor with single-actuation access to a full range of standard letter inputs.

While the foregoing description refers to a keyboard configuration for English letters or alphabets, the present invention is not limited to data entry in English only. The present invention may be Unicode-enabled for data entry in other European languages. The present invention is also equally applicable to other languages such as, but not limited to, Indian (Devanagari), Russian (Cyrillic), Chinese (Kanji), Japanese (Kanji, Hiragana and Katakana), Korean, That and Arabic scripts.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. An input device for entering data into a computing device, the input device comprising:
a supporting structure;
a plurality of primary keys mounted on the supporting structure, and
at least one of the primary keys comprising a multi-function input device operable by a single finger of a user and having a plurality of actuation modes each of which is associated with different input data for the computing device,
wherein the multi-function input device comprises a pad mounted over a plurality of momentary action switches whereby rocking the pad in each one of a plurality of directions operates a corresponding one of the switches;
wherein the multi-function input device further comprises a further switch which is operated by depressing the pad without rocking it;
wherein the multi-function input device further comprises five switches whereby rocking the pad in each one of four directions on substantially perpendicular axes operates a corresponding one of four switches and depressing the centre of the pad operates the fifth switch.

2-4. (canceled)

5. The input device as claimed in claim 1 wherein a first secondary key is provided to perform a shift function and operation of each of the primary keys generates one of a plurality of un-shifted inputs or one of a further plurality of shifted inputs.

6. The input device as claimed in claim 5 wherein five primary keys are positioned relative to one another along approximately arcuate line such that the tips of the four fingers and thumb of a user's hand will naturally adopt the positions of the primary keys; each primary key is assigned a maximum of one actuation mode associated with an input data value comprising a vowel selected from the group of “a”, “e”, “i”, “o” and “u”; wherein
an “s”, an “a”, an “l” and a “c” are assigned to a first of the primary keys,
a “d”, an “i”, an “m” and a “p” are assigned to a second of the primary keys,
an “f”, a “v” and an “x” are assigned to a third of the primary keys,
a “z”, a “q” and a “j” are assigned to a fourth of the primary keys,
a “w”, a “u”, a “k” and a “y” are assigned to a fifth of the primary keys.
a “t”, an “e”, an “r” and an “n” are assigned to a first secondary key, and
an “h”, an “o”, a “b”, and a “g” are assigned to a second secondary key.

7-8. (canceled)

9. The input device as claimed in claim 6, wherein the third secondary key is located proximate to one of the primary keys, wherein the third secondary key and the proximate primary key are alternatively accessible by a single finger or thumb; wherein
a fourth secondary key is located proximate to another of the primary keys, wherein the fourth secondary key and the proximate primary key are alternatively accessible by a single finger and the second secondary key also provides a shift function

10. (canceled)

11. The input device as claimed in claim 1, further comprising a positioning device arranged proximate to one of the primary keys, wherein the positioning device and one of the primary keys are alternatively accessible by a single finger in use.

12. The input device as claimed in claim 1, further comprising adjustment means associated with at least one of the primary or secondary keys wherein the position of the associated primary or secondary key is movable relative to the other keys by operating the adjustment means.

13. The input device according to claim 12, wherein the adjustment means comprises a knob or lever.

14. The input device as claimed in claim 5, wherein the supporting structure includes an opening formed in the supporting structure to receive a hand and the primary and the secondary keys are located in the opening and accessible by placing a hand in the opening.

15. The input device as claimed in claim 14, wherein the supporting structure is contoured to conform to a hand.

16. The input device as claimed in claim 14, wherein the supporting structure is arranged to be worn on a person.

17. The input device as claimed in claim 16, wherein the supporting structure is a glove.

18. The input device as claimed in claim 17, wherein the undersurface of the glove includes a screen.

19. The input device as claimed in claim 1, the input device being incorporated in a computing device further comprising:
a display; and
a processor capable of receiving data from the input device and outputting the data on the display, wherein the input device is a keyboard comprising:
a housing; and
a plurality of keys mounted in the housing, at least some of the keys being positioned relative to one another along an approximately arcuate line such that the tips of the four fingers and thumb of a user's hand will naturally adopt the positions of the primary keys.

20. An input device for entering data into a computing device using a single-hand operation, the input device comprising:
a supporting structure; and
a plurality of keys mounted in the supporting structure, at least a portion of the keys being positioned relative to one another along an approximately arcuate line such that the tips of the four fingers and thumb of a user's hand will naturally adopt the positions of the primary keys,
wherein each of the keys is assigned a plurality of inputs, each of the inputs is generated by a single actuation of a corresponding key, and
wherein the keys are capable of generating inputs corresponding to a full range of English letters.
